(19) United States
(12) Patent Application Publication
(10) Pub. No.: US 2004/0040235 A1
(43) Pub. Date: Mar. 4, 2004

(54) Baseboard with wire-containing channel

(76) Inventor: John L. Kurtz, Westminster, CA (US)

Correspondence Address: Averill & Varn, 8244 Painter Ave., Whittier, CA, 90602, US

(21) Appl. No.: 10/042,680

(22) Filed: Jan. 11, 2002

(51) Int. Cl. E04F 19/04; H02G 3/04

(52) U.S. Cl. 52/288.1; 52/290; 52/289; 52/220.5; 52/718.04; 174/49

(57) ABSTRACT

A baseboard assembly for covering lengths of wire behind a baseboard surface. The baseboard assembly has a wire channel and board support member attached to the wall. This member has an outwardly facing wire channel and a baseboard holding bar along its top edge. A baseboard is held to the wire channel and board support member by lowering a tongue and groove in the baseboard into a matching tongue and groove in the wire channel and board support member. The baseboard has a face which extends over the wire-containing channel. The baseboard may be cut and various outlet accessible fittings formed in an insert along the baseboard.

### BACKGROUND OF THE INVENTION

The field of the invention is baseboards and the invention relates more particularly to baseboards of the type which include an elongated channel for running wires behind the baseboard With the ever-increasing use of electronic devices, and especially computers and computer accessories, there is a growing need to provide a method where wires going between various wall outlets or various computer or electronic accessories can be run along behind a baseboard. This eliminates the unsightly and inconvenient presence of wires lying on top of the floor in front of a baseboard.

Various baseboard assemblies have been devised for this general purpose. U.S. Pat. No. 6,216,406 shows a baseboard with an inwardly facing channel to conceal and protect cables or wires installed within the channel. Openings are provided at the top of the baseboard to provide a place for gaining access to the wires and cables.

U.S. Pat. No. 6,202,380 shows another structure of baseboard which has an inwardly facing channel covered by a molding top over an upper portion of the channel. Means are provided in the bottom of the baseboard for running conduit out of the bottom of the channel.

A resin baseboard is shown in U.S. Pat. No. 5,598,681. The resin baseboard is extruded and a channel is molded in the inner piece. A cover is configured to snap over the channel to cover it.

While these baseboard assemblies provide some wire covering and routing features, they are deficient in the ability to be modified to add additional accessories or change the location of previously added accessories.

### BRIEF SUMMARY OF THE INVENTION

It is an object of the present invention to provide a baseboard assembly having the flexibility of adding or subtracting conductors and receptacles at any desired location. The present invention is for a baseboard assembly attached at the base of a wall adjacent the floor. The assembly has a wire channel and board support member attached to the wall. This member has a wall-contacting face affixed to the wall. A wire-containable channel is formed in an outwardly facing surface of this member. The member has a top edge which includes tongue and groove. A baseboard is held over the wire channel and board support member. The baseboard has a lowermost edge positioned in front of the bottom edge of the wire channel and board support member. The baseboard has an outer face extending upwardly to an uppermost end. The baseboard back surface extends downwardly from the top end and is positioned adjacent the wall. The back surface terminates in a tongue and groove assembly, which fits the tongue and groove of the wire channel and board support member. The baseboard also has a wire-containable channel covering face which extends over the wire-containable channel downwardly to the lowermost edge of the baseboard. The baseboard assembly has one or more baseboard inserts having vertical walls which fit in a pair of vertical cutouts formed in the baseboard. Preferably, the wire-containable channel has one or more wire holding clips held to the top and bottom edges of the wire-containable channel to assist in supporting the wire in the channel during assembly. Preferably, the wire-holding clip snaps into upper and lower grooves above and below the channel. The generally rectangular baseboard insert can be relatively large and include the support of a complete junction box with a plurality of electrical outlets. The junction box can be provided with a cover supported by the insert.

### BRIEF DESCRIPTION OF THE DRAWINGS

FIG. 1 is an exploded perspective view of the baseboard assembly of the present invention.

FIG. 2 is a cross-sectional view taken along line 2-2 of FIG. 1.

FIG. 3 is a cross-sectional view of wire channel and board support member of the baseboard assembly of FIG. 1.

FIG. 4 is a perspective view of a wire-holding clip for insertion into the wire channel and board support member of FIG. 3.

FIG. 5 is a cross-sectional view taken along line 5-5 of FIG. 1.

FIG. 6 is a perspective view of a baseboard insert holding a junction box and junction box cover insertable into the baseboard assembly of FIG. 1.

FIG. 7 is a cross-sectional view taken along line 7-7 of FIG. 6.

### DESCRIPTION OF THE PREFERRED EMBODIMENTS

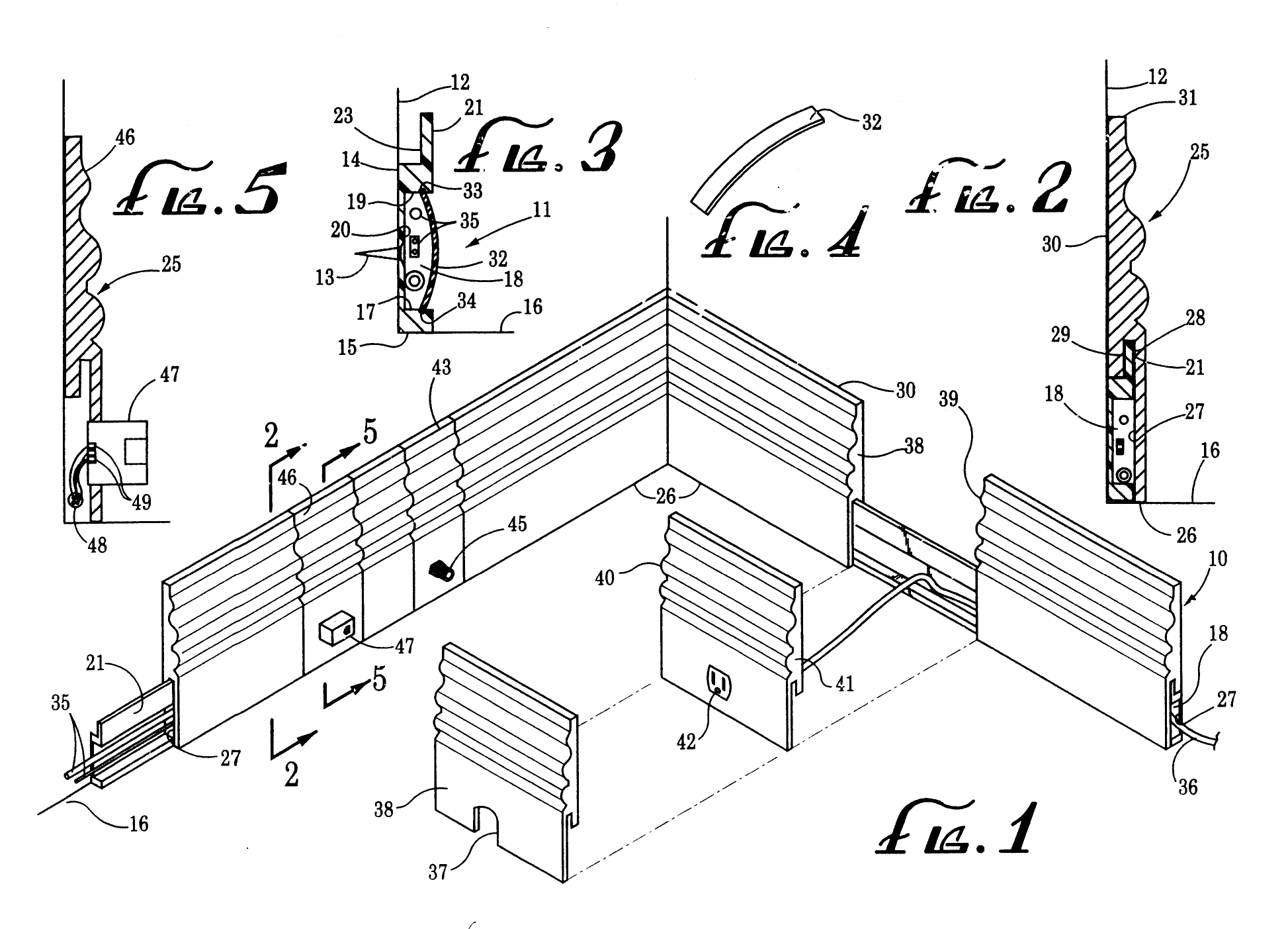

The baseboard assembly of the present invention is shown in FIG. 1 and indicated generally by reference character 10. Baseboard assembly 10 is basically made up of two pieces. The first is a wire channel and board support member 11, shown best in FIG. 3, which is attached to a wall 12 by one or more screws 13, nails, or by an adhesive or any other appropriate means. Wire channel and board support member 11 has a wall-contacting face 14 which contacts wall 12. A bottom edge 15 is positioned above floor 16 and may have a notch as shown in FIG. 3. A lower face 16 extends above bottom edge 15 and extends upwardly to a channel bottom edge 17. This forms the bottom edge of wire-containable channel 18 which extends upwardly to a channel top edge 19. Channel 18 has a back face 20, which is generally smooth, although it may support a plurality of wire holding hooks (not shown).

Channel top edge 19 extends to an upper face 21 which forms part of the outwardly facing surface of the wire channel and board support member. Upper face 21 ends in a top edge 22 which forms part of a baseboard holding tongue 23. A baseboard supporting groove 24 extends downwardly until it intersects with wall contacting face.

A baseboard 25 may be easily held to the wire channel and board support member 11 by simply being slid downwardly along the wall until its tongue and groove assembly fits into the tongue and groove assembly of the wire channel and board support member. More specifically, as shown in FIG. 3, baseboard 25 has a lowermost edge 26, which extends approximately to floor 16. A wire-containing channel covering face 27 touches lower face 16 and extends over the wire-containable channel 18. It extends upwardly and also contacts upper face 21. The baseboard has a top edge containing groove 28 and a downwardly extending tongue 29. Tongue 29 extends rearwardly to back surface 30 which contacts wall 12. The baseboard has an uppermost end 31.

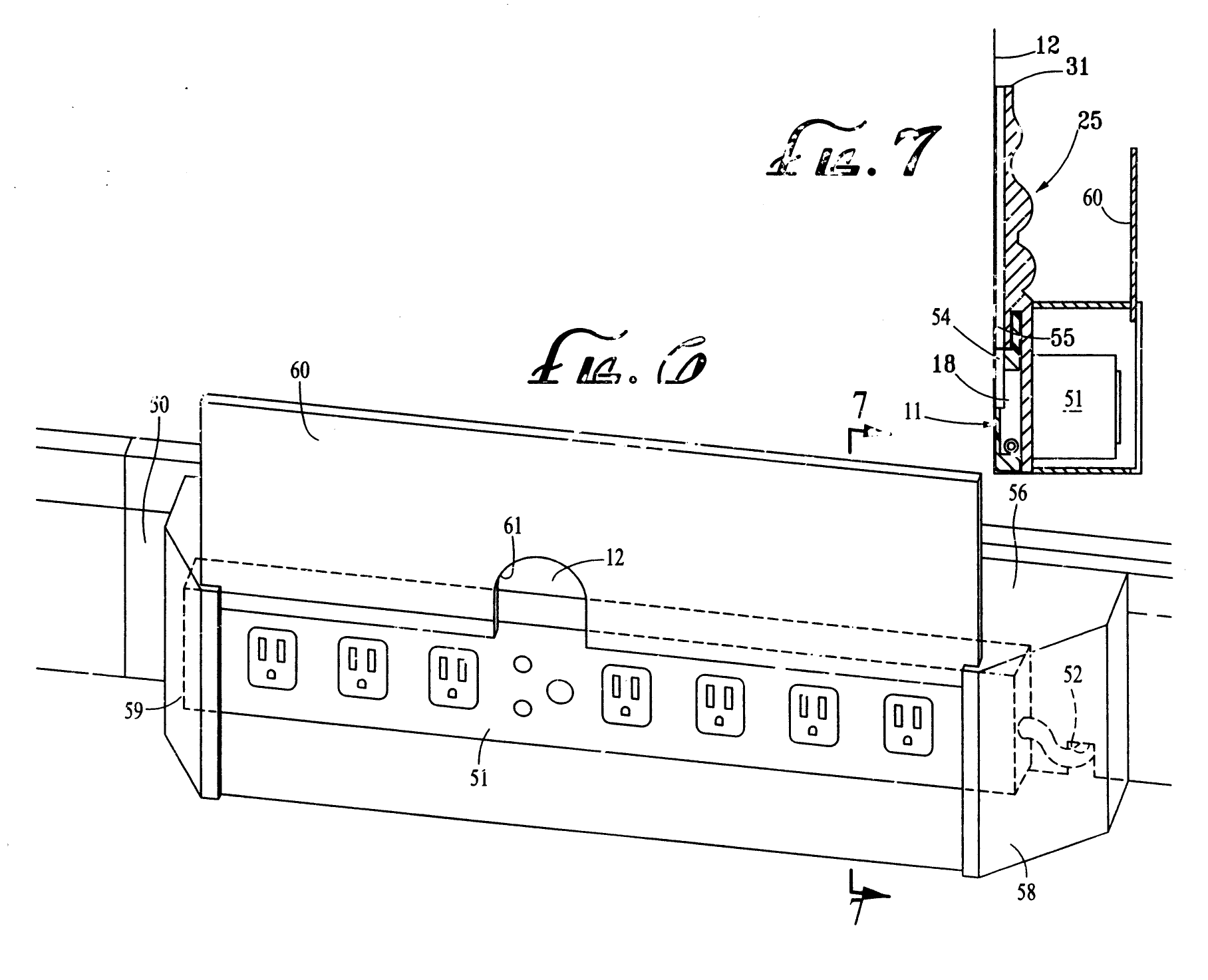

As shown in FIGS. 3 and 4, a wire holding clip 32 is preferably formed in a curved configuration and made from a flexibly non-conductive material, such as PVC. It is preferably bendable and fits into an upper and lower groove 33 and 34, respectively. As many wire holding clips 32 may be used as is needed to hold wires such as wires 35 shown in FIG. 3 in the wire-containable channel 13. This assists in the later insertion of the baseboard.

Since the baseboard is readily lifted out of the wire channel and board support member, it may be easily removed and one or more sections cut out thereof. Thus, either during the initial installation or later on for modification, the baseboard may be lifted up and a measured pair of vertical cuts made therein. For instance, as shown in FIG. 1, if it is desired to add an electrical outlet, an insulated conductor 36 may be passed into wire-containable channel 18 through a cutout 37, such as that shown in insert 38 and run along the channel 18 until an opening formed between the vertical baseboard left edge 38 and the vertical baseboard right edge 39 formed by the above-mentioned cutting process. Then the insert, which likewise has a vertical left edge 40 and vertical right edge 41, together with a supported electrical outlet, may be inserted in the space provided as shown in the right portion of FIG. 1. An insert 43 containing a coaxial cable outlet 45 may be inserted where desired, as may a spacing insert 44, which may be cut to any desired length to fill a space between various electronic outlets. A telephone jack containing insert 46 holds a telephone jack 47, which is shown in cross-sectional view in FIG. 5. The conductors of a telephone cable 48 may be soldered to the appropriate pins 49 on the back of telephone jack 47. Alternatively, the telephone jack 47 may be passed through a cutout, such as cutout 37, shown in FIG. 1.

In many instances, particularly behind a high fidelity sound system, or computer; it is desired to have a plurality of electrical outlets This can neatly be accomplished as shown in FIGS. 6 and 7 by providing a relatively large insert, such as junction box insert 50 shown in FIG. 6. Junction box insert 50 has a junction box 51 held against the outer face of insert 50. The conductor from the junction box 51 may be passed into the wire-containable channel 18 in numerous ways. The conductor 53 may go through opening 52 into channel 18. Also, conductor 53 may be passed upwardly through a cutout 54 in the wire channel and board support member 11.

Junction box 51 may be covered by a fixture covering box 56 which may be permanently or removably affixed to junction box insert 50. Box 56 has a top 571 sides 58 and 59, and a front cover 60. Front cover 60 may be a sliding door as shown in 56, or may be hinged or otherwise snapped over the front opening of the fixture covering box 56. A relatively large cutout 61 permits a plurality of wires to pass from junction box 51 out of the fixture covering box 56.

The result of the construction of the baseboard assembly of the present invention with its outwardly facing wire-containable channel provides surprising flexibility, ease of installation, and ease of modification. Typically, the wire channel and board support member would be extruded from a polymer and the baseboard could either be made from wood or also extruded from a polymer. It is important that the baseboard be capable of being cut so that inserts may be inserted where desired.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A baseboard assembly attached at the base of a wall adjacent a floor comprising:
a wire channel and board support member attached to said wall, said wire channel and board support member having a wall-contacting face affixed to said wall, said wire channel and board support member having a bottom edge, an outwardly facing surface having a lower face extending upwardly from said bottom edge, a wire containable channel formed in said outwardly facing surface above said lower face, an upper face located above said wire containable channel, a top edge located at the top of said upper face, a baseboard supporting groove formed in said top edge comprising a recess in said top edge, said upper face and said top edge surrounding a baseboard holding tongue in front of said baseboard supporting groove;
a baseboard held by said wire channel and board support member, said baseboard having a lowermost edge positioned in front of the bottom edge of said wire channel and board support member, said baseboard having an outer face extending upwardly to an uppermost end, a back surface extending downwardly from said top end and positioned adjacent said wall, said back surface including a tongue held in said baseboard supporting groove, said back surface also including a baseboard tongue holding groove and said back surface having a wire containable channel covering face which extends over said wire containable channel downwardly to said lowermost edge of said baseboard.

2. The baseboard assembly of claim 1 wherein said wire containable channel contains at least one wire, said wire passing through an opening formed in a generally rectangular baseboard insert having a vertical insert right edge and a vertical insert left edge abutting a matching vertical baseboard right edge and a vertical baseboard left edge and said generally rectangular baseboard insert having a matching profile at its vertical insert right and left edges as the profile of said vertical baseboard right and left edges whereby wire passageways can be located along said baseboard where desired.

3. The baseboard assembly of claim 1 wherein said wire containable channel contains at least one wire, said wire having a terminus affixed to a socket member, said socket member being supported in a generally rectangular baseboard insert having a vertical insert right edge and a vertical insert left edge abutting a matching vertical baseboard right edge and a vertical baseboard left edge and said generally rectangular baseboard insert having a matching profile at its vertical insert right and left edges as the profile of said vertical baseboard right and left edges whereby wire terminations can be located along said baseboard where desired.

4. The baseboard assembly of claim 1 wherein said wire containable channel has a top edge, a bottom edge and a back face and contains at least one wire holding clip held by said top edge and bottom edge of said wire containable channel.

5. The baseboard assembly of claim 4 wherein said wire holding clip is held between an upper groove formed in said top edge of said wire containable channel and a lower groove formed in said bottom edge of said wire containable channel and wherein said wire holding clip is fabricated from a generally rigid but flexible material whereby it can be snapped into said upper and lower grooves where desired.

6. The baseboard assembly of claim 5 wherein said wire holding clip is curved and is inserted so that it is curved outwardly with respect to said upper groove and said lower groove when held in said wire containable channel.

7. The baseboard assembly of claim 1 wherein said wire containable channel contains at least one wire, said wire having a terminus affixed to a junction box, said junction box being supported in a generally rectangular baseboard insert having a vertical insert right edge and a vertical insert left edge abutting a matching vertical baseboard right edge and a vertical baseboard left edge and said generally rectangular baseboard insert having a matching profile at its vertical insert right and left edges as the profile of said vertical baseboard right and left edges, said junction box extending outwardly with respect to an outer face of said generally rectangular baseboard insert.

8. The baseboard assembly of claim 7 wherein said junction box is covered by a fixture covering box held by said generally rectangular baseboard insert, said fixture covering box having a top, two sides and a front and an openable front door.

9. The baseboard assembly of claim 8 wherein said junction box has an insulated conductor passing through a portion of said wire containable channel and through a cut out in said baseboard holding bar and a cut out in said back surface of said baseboard and said insulated conductor extending upwardly above said baseboard for connection to an electrical outlet supported by said wall.
